(19) United States
(12) Patent Application Publication
(10) Pub. No.: US 2008/0156423 A1
(43) Pub. Date: Jul. 3, 2008

(54) APPARATUS FOR MOUNTING LAMINATES ON SUBSTRATES AND METHODS THEREOF

(75) Inventor: Robert J. Reuter, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/618,050

(22) Filed: Dec. 29, 2006

(51) Int. Cl. B44C 1/165; B65H 37/04

(52) U.S. Cl. 156/230; 156/540

(57) ABSTRACT

Method, apparatus, and kit utilize a film mounting tool for sizing, shaping, and supporting a laminate, such as window film, that is to be installed on a substrate, such as a transparent panel. The film mounting tool is used for: conforming the laminate to the size and shape of the film mounting tool, delaminating the laminate placed on the film mounting tool so as to expose an adhesive layer thereof, and for supporting and carrying the laminate during an installation process so that the adhesive layer can be pressed onto the substrate by the film mounting tool.

### CROSS REFERENCE TO RELATED APPLICATIONS

The present application is related to copending and commonly assigned U.S. patent applications: U.S. patent application (Attorney Docket No. 62687US002) entitled “Window Film Assembly and Method of Installation”; U.S. patent application (Attorney Docket No. 62688US002, entitled “Window Film Frame Assemblies For Installation Over Windows And Methods”; and U.S. patent application (Attorney Docket No. 62689US002) entitled “Apparatus For Mounting Film Structures And Methods”; all of which are filed concurrently herewith.

### BACKGROUND

The present invention relates generally to apparatus and methods for mounting laminates on substrates, and, more particularly, to apparatus and methods including a film mounting tool adapted for mounting window films on transparent substrates, such as windows or the like.

Window films are generally transparent plastic and/or metallized laminates that are applied as a thin layer to transparent panels, such as glass windows. Window films are available, in many different compositions for bringing about varying effects on the optical and mechanical properties, of the underlying transparent panels. Window films can reduce energy costs by minimizing the amount of heat entering a building through sunlight, thereby decreasing the amount of energy needed to cool the building. Window films also act as a filter for reflecting most ultraviolet and infrared wavelengths while allowing passage of visible light. This can result in substantial reductions in cooling costs. As noted, such films reduce the amount of ultraviolet entering a window, and are also often applied to reduce fading of the contents of a room. Other kinds of thin window films include security films that are applied to prevent glass from shattering, as well privacy films for controlling the visible light transmitted for effecting privacy purposes.

It will be appreciated that several factors are considered in selecting the correct film to be installed on a window. Such factors include visible light transmission, properties of solar energy to be reflected, and aesthetic considerations when installed.

Because window films are usually installed by applying them to either or both surfaces of flat finished glass, the resulting laminates are less costly than buying chemically altered specialty glass for bringing about the same desired solutions. Additionally, window films can be applied directly to existing windows for effectuating such solutions retroactively. Because window films provide energy savings and help protect furnishings among other advantages, they are generally considered to be an investment that helps pay for itself. As such, they have gained widespread commercial acceptance.

However, due to the inherent mechanical and chemical properties of these films, their installation can be tedious and subject to several shortcomings particularly in a do-it-yourself context. Generally window films are thin and may be difficult to handle, especially if large window panels are to be laminated. For example, window films are relatively thin, such as up to 4 mils. These thin films have a tendency to fold upon themselves. Measuring and cutting thin films to the correct size before they are directly applied is particularly difficult, especially if irregular window shapes are involved and installation is performed by non-professionals, such as a do-it-yourself installer. Additionally, most window films are covered by a release sheet that must be removed before application of the film oh the window. However, there is a strong tendency for the thin adhesive covered film surface to permanently wrinkle, crumple, or crease as the release sheet is manually removed. Accordingly, these film surfaces may stick to themselves even before the release sheet is completely removed. Creasing, wrinkling, etc. may cause permanent film flaws eventually that lead to discarding the films.

The light and flexible nature of these very thin window films also exhibit a tendency to react to air movements, such as those encountered by while the films are carried and mounted by an installer. As such, their adhesive surfaces may both curl and stick to themselves or other objects that they may inadvertently engage (e.g., furniture, window frame, etc.) during installation. This likelihood is increased as the size of the laminate increases. Accordingly, these factors present further opportunities for the window films to be damaged and perhaps eventually discarded. This results in unnecessary additional costs associated with using extra window film as well as increasing the time and/or labor costs associated with their installation.

Moreover, precisely applying the thin cut films to the windows is relatively difficult because of the noted tendencies of films to fold or drape over on themselves while being installed. In addition, dust particles or the like may be attracted to the exposed adhesive surface during installation. Dust particles or the like may result in a less than perfect transparency following installation. Even minute mistakes will produce an unsightly finish on transparent surfaces.

Due to the number and complexity of steps involved installing thin window films is generally considered time consuming, demanding, as well as potentially costly due to film and time wastage. Because of these issues, professional installers are often employed since homeowners are not equipped to be able to easily perform the installation.

Thus, needs exist for providing low cost, simple, and reliable lamination approaches for mounting laminates, such as window films on substrates, such as windows. These needs include being able to easily and reliably cut the laminates to accurate shapes and sizes of the object to be laminated. These needs further include being able to delaminate release sheets from the laminate to expose adhesive in a manner that avoids or minimizes the likelihood of the exposed surfaces creasing or crumpling, thereby rendering them useless. These needs further include being able to support and control such laminates when they are carried and installed so as to avoid the adhesive surface creasing and sticking together. In addition, needs exist for achieving the foregoing inexpensively and in a time efficient manner that lessens installation time and minimizes costs and or the need for additional or professional installers.

Without such needs being satisfied the true potential of laminating such kinds of laminates, such as window films, on substrates, such as windows will not be fully achieved, especially in a simple, reliable, and less time consuming and costly manner.

### SUMMARY

The present invention provides enhanced methods, apparatus, methods of making such apparatus, and a kit adapted for installing laminates, such as window films, to corresponding substrates, such as transparent panels, in a manner that represents improvements over prior art approaches.

The foregoing shortcomings are overcome or minimized by a method of installing a laminate on a substrate, wherein the method comprises: generating a film mounting tool by cutting a blank sheet to generally match the size and shape of the substrate, providing a laminate, joining the laminate to the film mounting tool so that mutually opposing major surfaces of both are in a generally juxtaposed and coextensive relationship with each other whereby the mounting tool supports the laminate, cutting the laminate so that its shape and size generally conforms to that of the film mounting tool, and applying the laminate by using the film mounting tool to press the laminate against the substrate.

The present invention provides a method of forming an apparatus adapted for sizing, shaping, and supporting a laminate during installation on a substrate, the method comprises: providing a foldable blank sheet, forming one or more folds in the blank sheet for generally matching a size and shape of a boundary of the substrate, and generating the apparatus by cutting the blank sheet adjacent the one or more folds so that its size and shape generally conform to the boundary of the substrate.

The present invention provides a film mounting tool apparatus adapted for sizing, shaping, and supporting a laminate to be installed on a substrate, the apparatus comprising: a blank sheet that is made of a material that is foldable and able to be cut to conform it to the size and shape of a boundary of the substrate, the blank sheet includes one or more adhesive surfaces that are releasably attachable to the substrate to facilitate folding and cutting the blank sheet into the tool apparatus so that the tool apparatus matches generally to the boundary of the substrate, the one or more adhesive surfaces facilitate joining the tool apparatus to the laminate whereby the latter can be more precisely cut to match the size and shape of the tool apparatus, and the blank sheet material supports and controls movement of the cut laminate while the latter is applied to the substrate.

The present invention provides a kit comprising: a blank sheet that is made of a material that is foldable and able to be cut to conform it to the size and shape of a boundary of the substrate, the blank sheet includes one or more adhesive surfaces that are releasably attachable to the substrate to facilitate folding and cutting the blank sheet into a film mounting tool apparatus that matches generally the boundary of the substrate, the one or more adhesive surfaces facilitate joining the tool apparatus to the laminate whereby the latter can be more precisely cut to match the size and shape of the tool apparatus, and the blank sheet material supports and controls movement of the cut laminate while the latter is applied to the substrate, and a thin laminate to be mounted on the substrate and joinable thereto so as to be sized and shaped to match the size and shape of the tool apparatus.

An aspect of the invention is the provision of method, apparatus, and kit for improving the lamination of laminates to a substrate.

An aspect of the present invention is a method, apparatus, and kit that achieve the foregoing in a manner that minimizes significantly the time of installing laminates, such as window films on substrates, such us transparent panels.

An aspect of the present invention is a method, apparatus, and kit that achieve the foregoing in a manner that minimizes significantly the costs of installing laminates, such as window films on substrates, such as transparent panels.

Another aspect of the present invention is a method, apparatus, and kit that achieve the foregoing in a manner that increases significantly the reliability of installing laminates, such as window films on substrates, such as transparent panels.

An aspect of the present invention is a method, apparatus, and kit that achieve the foregoing in a manner that minimizes significantly the time of sizing and shaping laminates, such as window films for use on substrates, such as transparent panels.

An aspect of the present invention is a method, apparatus, and kit that achieve the foregoing in a manner that minimizes significantly the costs of sizing and shaping laminates, such as window films for use on substrates, such as transparent panels.

Another aspect of the present invention is a method, apparatus, and kit that achieve the foregoing in a manner that increases significantly the reliability of sizing and shaping laminates, such as window films for use on substrates, such as transparent panels.

An aspect of the present invention is a method, apparatus, and kit that achieve the foregoing in a manner that significantly improves control over movement of the laminates during lamination on a substrate.

Still another aspect of the present invention is a method, apparatus, and kit that achieve the foregoing in a manner that significantly diminishes damage to laminates by the latter curling or folding upon themselves of engaging other materials during installation.

Still another aspect of the present invention is a method, apparatus, and kit that enables delaminating of release sheets from laminates so as to expose adhesive layers thereof in a manner that avoids damage to the adhesive layers.

The aspects described herein are merely a few of the several that can be achieved by using the present invention. The foregoing descriptions thereof do not suggest that the invention must only be utilized in a specific manner to attain the foregoing aspects.

These and other features and aspects of this invention will be more fully understood from the following detailed description of the preferred embodiments. It should be understood that the foregoing generalized description and the following detailed description are exemplary and are not restrictive of the invention.

### GLOSSARY

As used herein, the term “laminate” can mean a layer of a material on a substrate, using the same or different materials of the substrate being laminated.

As used herein, the term “transparent” means allowing an effective proportion of radiation to pass therethrough.

### BRIEF DESCRIPTION OF THE DRAWINGS

FIG. 1 is a schematic view of a template sheet used for forming a film mounting tool made accordance to the present invention and shown in juxtaposed relationship with a thin window film laminate that is to be mounted on a transparent panel or window of the underlying window assembly.

FIG. 2A is a schematic view of one aspect of a method of forming the film mounting tool, wherein a template sheet is creased to define a boundary of the tool that corresponds to a surface of the window to be laminated.

FIG. 2B is a schematic view of a film mounting tool made according to the present invention.

FIG. 3 is a schematic view of a window film laminate being placed over the film mounting tool.

FIG. 4 is a schematic view of a window film laminate being cut so that it matches the size and shape of the film mounting tool.

FIG. 5 is a schematic view of a window being cleaned prior to the film being laminated thereto.

FIG. 6 is a schematic view of a release liner being removed from a film laminate.

FIG. 7 is a schematic view of water being applied to an adhesive surface of the film laminate.

FIG. 8 is a schematic view of the film mounting tool and the window film being installed on the window surface.

FIG. 9 is a schematic view of the film mounting tool being removed from the window film laminate after the latter has been installed.

FIG. 10 is a schematic view of a squeegee process according to the present invention.

FIG. 11 is a schematic view of a window film laminated to the window.

### DETAILED DESCRIPTION

The words “a”, “an”, and “the” are used interchangeably with “at least one” to mean one or more of the elements being described. By using words of orientation, such as “top”, “bottom”, “overlying”, “front”, “back” and “backing” and the like for the location of various elements in the disclosed articles, we refer to the relative position of an element with respect to a horizontally-disposed body portion. It is not intended that the disclosed articles should have any particular orientation in space during or after their manufacture.

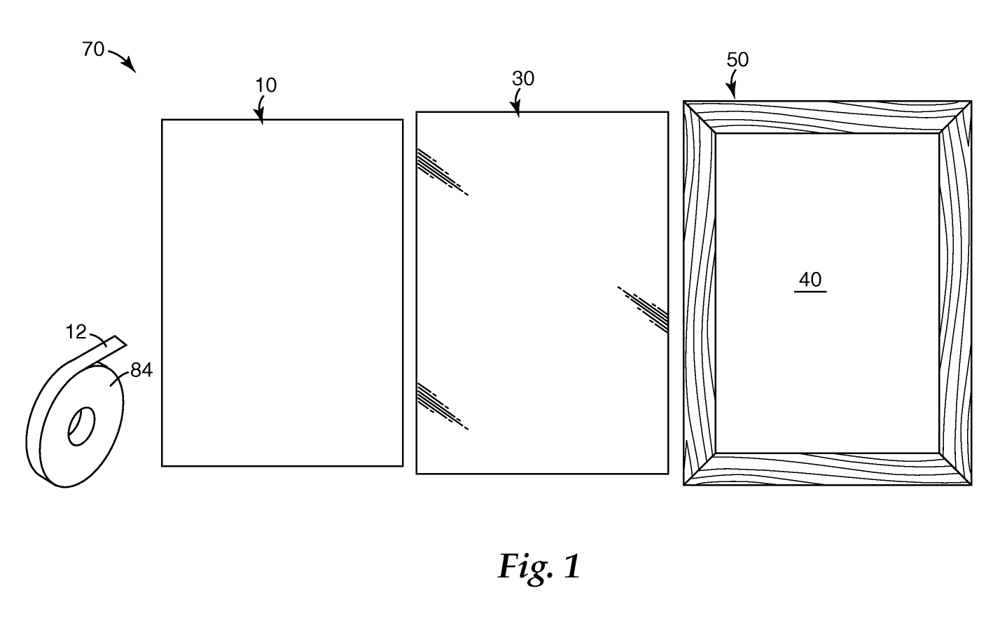

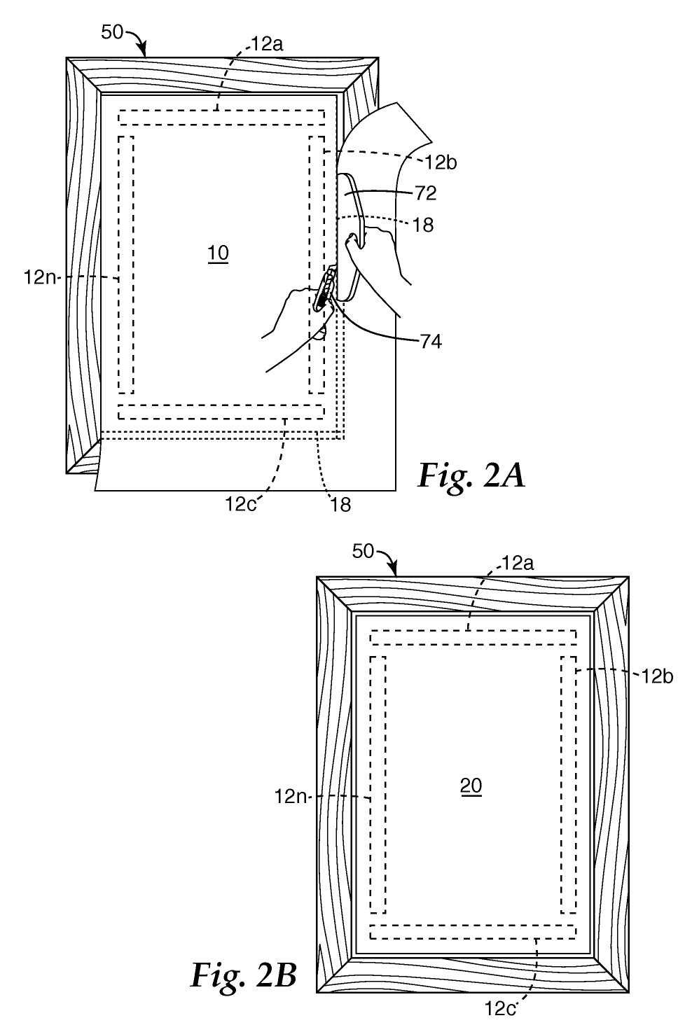

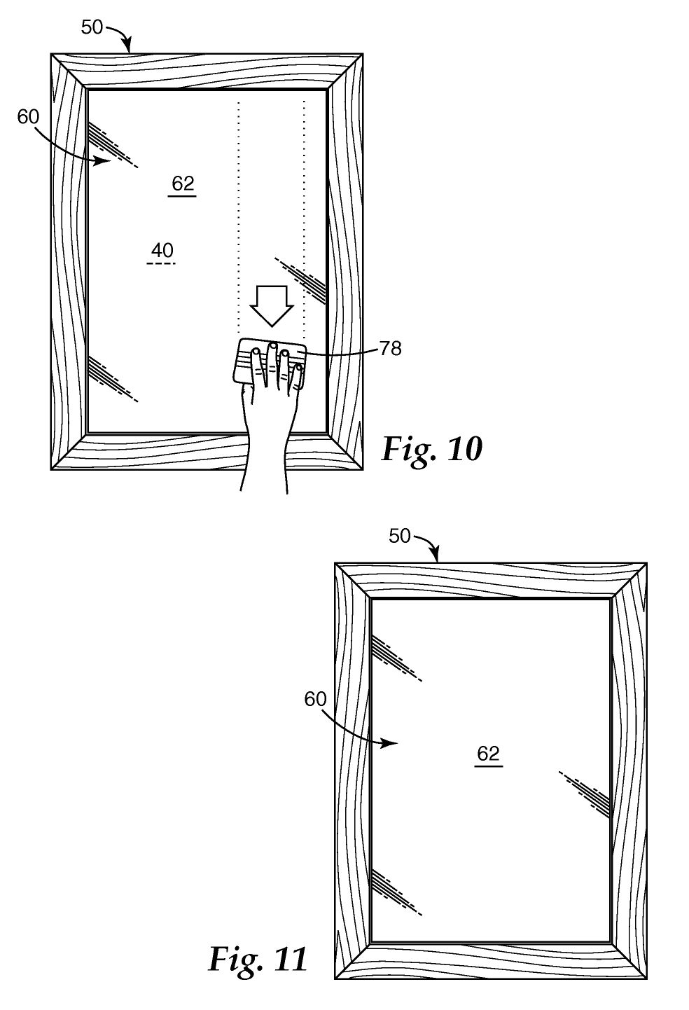

FIG. 1 is a schematic view of a working tool template blank or template sheet 10. It is to be used in forming a film mounting apparatus or tool 20 (FIG. 2B) according to a method of the present invention. The film mounting tool apparatus 20 is depicted in a juxtaposed relationship with an oversized laminate 30, such as a window film laminate 30 (FIGS. 1 & 3). As depicted, the window film laminate 30 has yet to be cut and mounted on a transparent panel 40, such as a window 40 (FIG. 1) of a window assembly 50 (FIG. 1). FIGS. 10 & 11 illustrate a laminated window assembly 60 including a properly sized, shaped, spaced, and installed window film laminate 62.

While the present invention provides enhanced installation methodologies for installing window films on corresponding transparent panels, such as windows or the like, it also envisions laminating thin film laminates to any suitable substrate. In addition, the present invention contemplates the utilization of a window laminating kit 70 (FIG. 1) for use in the context of do-it-yourself applications.

As seen in FIG. 2A, the template sheet 10 may be oversized relative to the window 40 prior to being cut. The template sheet 10 may be made of a thin, flexible and pliable material that is capable of being flexed or bent without tearing or breaking. It may be creased easily as at 18 along edges formed by the window assembly 50. This assists in defining a boundary that conforms generally in size and shape to the object to be laminated; (see window in FIG. 2B). The materials selected for the template sheet 10 may be durable to allow reuse. The installer can cut along or adjacent the creases 18 to thereby enable accurate sizing and shaping functions to be carried out.

The template sheet 10 may be comprised of one or more layers of a pliable material selected from a group consisting of, but not limited to materials, such as paper, non-woven materials, and sheet polymers. The template sheet 10 may have any suitable thickness. Thickness ranges are up to about 20 mils, and more typically between 5 to about 10 mils. The foregoing materials and/or thicknesses are selected so that the template sheet 10, when formed into the mounting tool apparatus 20, is relatively stiffer than the window film laminate 30 to be installed. The relatively higher stiffness diminishes tendencies of the more flexible window film laminate 30 to curl or fold upon itself When the two are carried in juxtaposition to each other. Additionally, the relatively higher stiffness tends to inhibit air currents from moving the window film laminate 30 in a manner that might cause it to bend or behave undesirably while being installed. The mounting tool apparatus 20 also tends to prevent an adhesive surface of the window film laminate contacting other structures, while the latter is conveyed to and mounted on the window.

In FIG. 2A, the template sheet 10 is creased along the edges of the window 40 and the window assembly 50. A spacer tool 72 having a preselected thickness creases or folds the template sheet against portions of the window assembly 50. A cutting tool 74 can then be used to cut the template sheet 10 adjacent the cutting tool 74. The spacer tool 72 in this embodiment has a thickness to ensure that there is a margin corresponding to its thickness around the window film laminate 30 after it is installed (see FIG. 11). Creases 18 serve to guide the installer while cutting. The crease(s) 18 also define the geometric shape of the mounting tool apparatus 20 to be formed.

Located adjacent at least one end portion of the template sheet 10 is one or more spaced apart adhesive articles or stripes or layers 12ₐ₋ₙ (collectively, 12). Alternatively, a major portion of one entire surface of template sheet 10 can have a pressure-sensitive adhesive layer covering it. The adhesive stripes 12 serve to releasably secure the template sheet 10 to the window 40 so that the film mounting tool 20 can be formed. The adhesive stripes 12 also releaseably secure the template to the window film laminate for the purposes to be described. In one illustrated embodiment, the adhesive articles or stripes 12 are pressure-sensitive type. The adhesive stripes 12 may be of the double-sided type. Also, the pressure-sensitive adhesive stripes 12 may be single-sided. In this latter regard, a substrate of the single-sided type may be permanently affixed or otherwise releaseably attached to the template sheet 10. The pressure-sensitive adhesive stripes 12 are typically positioned adjacent edges of the template sheet 10. However, they may be positioned at other locations depending on the size and shape of the window to be laminated.

As noted, one use of the pressure-sensitive adhesive stripes 12 is to be mounted on the template sheet 10 and then releaseably attached to the window 40 (FIG 2A) during formation of the working tool apparatus. As such this assists in holding the template sheet 10 in a juxtaposed and suspended relationship to the window 40, whereby the template sheet can be easily folded or creased and then cut by a single installer. No other installers need be present. As illustrated in FIG. 2A, the template sheet 10 is creased and cut to generally match the boundary of the window 40 to be laminated, whereby after being cut, the template sheet forms the mounting tool apparatus 20 (FIG. 2B). By reason of the foregoing process, there is a high degree of reliability that the mounting tool apparatus 20 matches the size and shape of the object to be laminated.

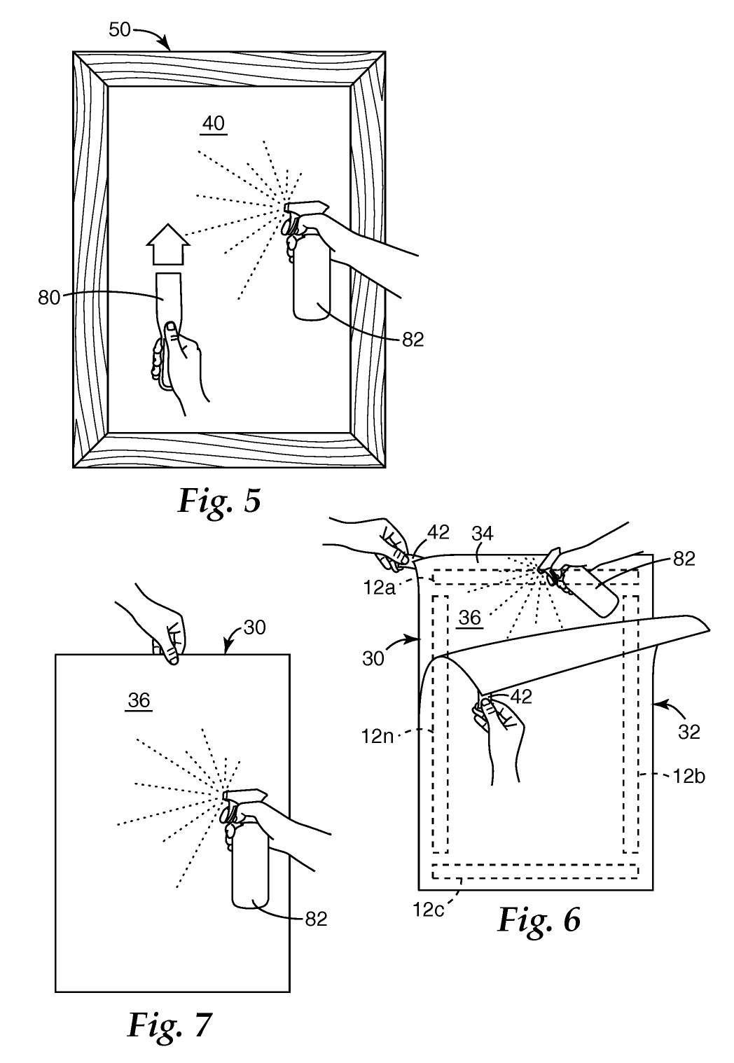

As seen in FIG. 4, the same pressure-sensitive adhesive stripes 12, now on the mounting tool apparatus 20, are intended to also be releasably joined or attached to the window film laminate 30 for creating advantages to be described. By having the mounting tool apparatus 20 and the window film laminate 30 releasably attached together, the latter may be more easily and accurately cut (see FIG. 5) by scissors so as to have it conform to the size and shape of the mounting tool apparatus and, thereby the window 40. Significantly, a release sheet 32, as seen in FIG. 6, can be delaminated in a manner that greatly minimizes or avoids creasing or folding of the remaining window film laminate 30. This is a significant advantage since even do-it-yourself installers might easily achieve successful delaminating with a high degree of probability of not damaging the remaining window film laminate.

The pressure-sensitive adhesive stripes 12 remain attached to the window film laminate 30 and allow the combination to be moved together. Also, the pressure-sensitive adhesive stripes 12 are capable of allowing delamination of the mounting tool apparatus 20 from the window film laminate 30 following installation of the latter on the window 40.

An installer can first attach the double-sided pressure-sensitive adhesive stripes 12 to the template sheet 10, for example, after the latter has been unrolled from a web roll 84 (FIG. 1) supplied in the window laminating kit 70. The adhesive stripe release sheets (not shown) have been removed from adhesive layers prior to the adhesive stripe being used. Suitable double-sided pressure-sensitive adhesive tapes, such as the transfer tapes available under the trade designations “SCOTCH #9416” or “SCOTCH #9415” from 3M Company (St. Paul, Minn.) may be used. Other suitable pressure-sensitive adhesives include but are hot limited to those adhesives associated with Post-it® Notes that are commercially available from 3M Company, St. Paul, Minn. While the adhesive articles or stripes 12 are described in spaced apart locations on the template sheet 10, such as along the edges, the stripes 12 may be placed at other locations as well. Instead of using a plurality of stripes, they may be joined into a single stripe (not shown). Double-sided pressure-sensitive adhesive stripe 12 are versatile insofar as an installer can place them in desired positions on the template sheet 10 to more easily accommodate mounting the latter to windows of all different sizes and shapes. The pressure-sensitive adhesive may be of any known type and can include removable and permanent types. Alternatively and/or additionally, one or more stripes or dots, and one or more different adhesives may be applied in any pattern.

Reference is made back to the window 40. As noted, it is one of many kinds of substrates that can be laminated according to this invention. The window 40 may be any type made of any suitable material, such as glass, transparent plastics or the like. Additionally, the window 40 can have any number of suitable optical, chemical and mechanical properties. The window 40 is surrounded by a suitable window assembly 50, such as the kind used for residential purposes. It will be appreciated that there exists a wide variety of window assemblies that may be used and the type depicted is for illustration purposes only.

The window film laminate 30 is used for changing the optical properties of the underlying window 40. Window film laminates are generally transparent, plastic and/or metallized laminates that are applied as thin layers to transparent panels, such as glass windows. Window film laminates are available in many different compositions for bringing about varying effects on the optical and mechanical properties of the underlying transparent panels. The present invention is not limited by the kind of window film laminate to be used.

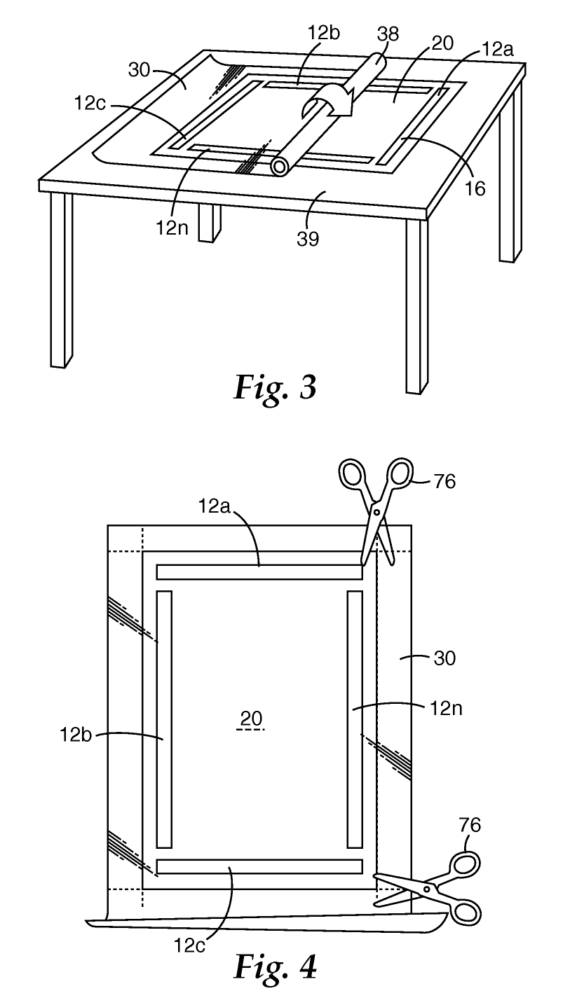

The window film laminate 30 may be made of several layers of polymer materials. One layer is a release sheet 32 and it is removed from the laminate base layer 34 so as to expose a pressure-sensitive adhesive surface layer 36 that is to remain laminated to the window 40. In this embodiment, the release sheet 32 covers a major surface of a pressure-sensitive adhesive surface layer 36 (FIG. 6) formed on the laminate base layer 34. Such a pressure-sensitive adhesive surface layer 36 would generally include release materials that allow the release sheet 32 to be removed from the pressure-sensitive layer 36 prior to the latter being applied directly to the window 40. While a pressure-sensitive adhesive is provided, other known, adhesives can be used. As noted, the release sheet 32 is delaminated after the window film laminate 30 has been placed over and secured to the working tool apparatus 20 (FIG. 3). Delaminating allows the surface of the pressure-sensitive adhesive surface layer 36 to be exposed for direct engagement and mounting on the window 40 (see FIGS. 9-11). The window film laminate 30 need not have a pressure-sensitive adhesive surface layer 36 to engage the window 40, but instead may rely upon surfaces that use, for example, static.

The window film laminate 30 in one illustrated embodiment includes a transparent multilayer structure that reflects light in the infrared and ultraviolet regions of the electromagnetic spectrum and transmits light in the visible region of the spectrum. The laminate base layer 34 of the laminate 30 may include a layer that effectively reflects up to about 99.9% of infrared and up to about 99% of ultraviolet. Other reflecting ranges for infrared and ultraviolet are contemplated. For instance, the amount of infrared reflected may range from about 0% to about 99%, while the amount of ultraviolet reflected may be in a range of 90-100. It will be appreciated that window film laminate bases 34 can possess other optical and mechanical properties. Window films of the type noted above generally have thicknesses ranging from about 1 to about 6 mils.

Typically, the polymer materials of the release sheet 32 include but are not limited to polyester. Typically, the polymer materials of the laminate base layer 34 that includes the optical properties of the laminate include but are not limited to polyester, vinyl, and other suitable materials. For example, one window film laminate 30 is Prestige™ window film, commercially available from 3M Company, St. Paul, Minn. Another kind of window film that may be used is Scotch® Tint window film, commercially available from 3M Company, St. Paul, Minn. Other kinds of suitable window film laminates may be used, such as solar window film, graphic design window film, privacy window film, security window film, frosted window film, and any combination thereof.

Reference is now made to FIG. 3 wherein the film mounting tool apparatus 20, formed as noted, is mounted flat on a table 39 or other like supporting surface. An oversized window film laminate 30 is unrolled from a web roll and directly mounted on the film mounting tool apparatus 20. As seen in FIGS. 3 & 4, the adhesive stripes 12 on the film mounting tool face upwardly, as illustrated, and are intended to directly engage the non-adhesive side 38 of the window film laminate 30. An installer can more easily and reliably cut and trim the perimeter of the window film laminate 30, such as by using scissors 76 or the like to match the size and shape of film mounting tool 20. The film mounting tool 20 acts as a template. Because of the noted adhesive contact, the window film laminate 30 and the mounting tool apparatus 20 remain together without movement to ensure accuracy in cutting. As such, because of the method of this invention there is provided a high degree of assurance that its size and shape will match that of the mounting tool. The template sheet 10 after being cut into a mounting tool apparatus 20 acts as a template for sizing and shaping corresponding sections of cut laminate 30. As noted, the mounting tool 20 also protects and provides support for the cut laminate base layer 34 that is to be installed.

Reference is now made back to FIG. 6, wherein prior to mounting the cut laminate base layer 34 on the window 40, the release sheet 32 is delaminated. Delaminating is achieved by having small masking tape tabs 42 placed on the corners of both, sheets. The installer grabs the tabs 42 and begins to peel the sheets apart. Because the base layer is adhered to the mounting tool apparatus 20 through the adhesive stripes 12, when a user pulls on the release sheet 32 any tendencies of the base layer 34 to crease or fold is greatly minimized or even avoided. This is a significant advantage over the prior art. To further facilitate such delaminating, a fluid, such as water, may be misted on the separating layers. The water applied tends to reduce static cling that would hamper a clean separation.

Reference is now made to FIG. 5, wherein the window 40 has a surface that is cleaned, such as by water containing a suitable cleaning agent. For instance, two cups of (500 ml) of water and the contents of the soap packet are placed in a spray bottle and shaken. The window 40 is misted and it can be scraped by a suitable scraper. A clean window surface will provide best results. Therefore, this process can be repeated as desired. As noted, any dirt left on the window will be trapped under the applied film. The window surface may even be scraped by a scraper 80. This is done in order to provide as smooth a surface as possible. Such cleaning steps can be repeated as necessary.

As seen in FIG. 7 the application fluid is applied onto the pressure-sensitive adhesive surface in a fine mist by a spray bottle 82 so that relatively uniform coverage of the pressure-sensitive adhesive surface is obtained. The window 40 may also be cleaned. In general, pressure-sensitive adhesive coated layers that are applied to window glass or other substrates are often applied with the aid of an application fluid typically comprising, for example, about 1 percent weight soap in water. Other suitable solutions for cleaning are envisioned. The application fluid aids in the positioning or aligning of the laminate on the substrate by interfering with the bond of the pressure-sensitive adhesive with the window thereby allowing the laminate to easily slide across the window.

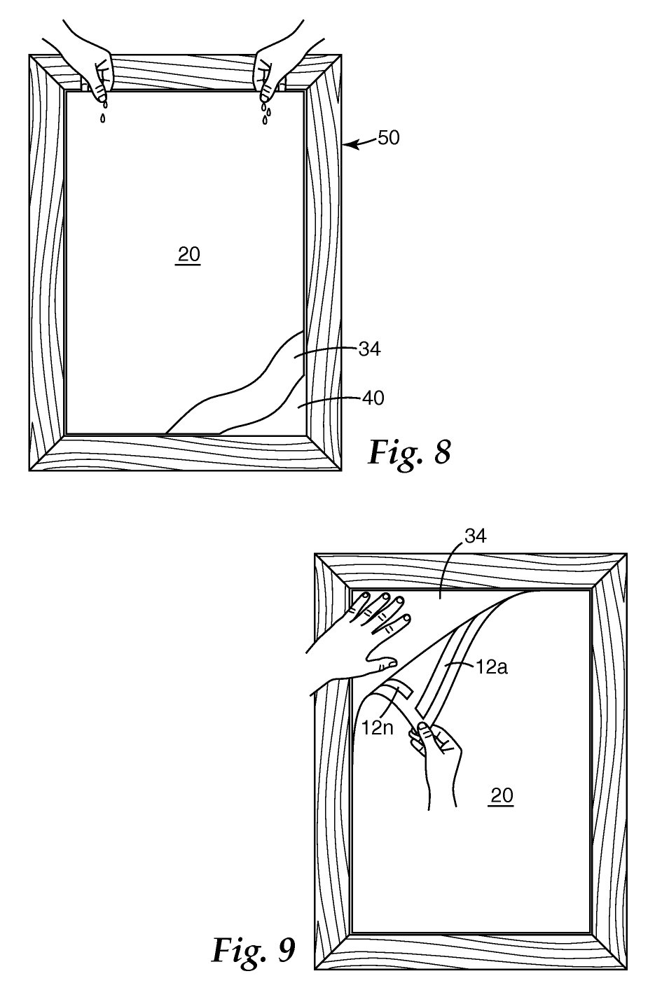

As seen in FIG. 8, an installer has carried both the mounting tool apparatus 20 and the cut laminate base layer 34 to the window 40. It will be understood that the pressure-sensitive layer (not shown) directly faces the window surface and is joined in intimate engagement therewith by pressing it against the window. The installer carries both the mounting tool apparatus 20 and the cut laminate base layer 34 from the table 39 to the window. The installer may have wet lingers and holds the top corners while carrying and applying them to the window. The relatively stiffer mounting tool apparatus 20 tends to provide support for the layer 34 and minimizes the chance of the latter folding on itself. The relatively stiffer mounting tool apparatus 20 also tends to provide support for preventing inadvertent contact of the pressure-sensitive adhesive layer 36 with other structures. As noted, the pressure-sensitive adhesive layer 36 engages a wet window surface during installation. After the layer 34 has been applied and aligned as by floating, the working tool apparatus 20 is delaminated from the laminate (FIG. 9). This is done by merely peeling the mounting tool apparatus 20 from the laminate layer 34 while the latter is firmly held against the window 40. As seen in FIG. 10, a card squeegee 78 may be used for drawing the fluid from between the window film laminate 62 and the window 40 after the window film laminate has been mounted and before it has been cured.

Aspects of the window laminating kit 70 are illustrated in various ones of the FIGS. 1-11. The window laminating kit 70 of the present invention may include one or more rolls of the window film laminate 30 of the kinds noted above, one or more template sheets 10. Included in the window laminating kit 70 is a spacer tool 72 for facilitating edge cutting, a cutting tool 74 for cutting the template sheets, scissors 76 for cutting the window film laminate, and a scraper 80 for cleaning substrates, a cleaning solution, such as soap, and instructions (not shown), a spray bottle 82 may be included for applying a fluid mist to the surfaces of the transparent panel and the laminate. The laminate and template sheets may be provided in the form of web rolls. The cutting tool 74 is provided for cutting along the creases formed in the template sheet 10 for making the mounting tool apparatus 20. The cutting tool 74 or the scissors 76 may also be used for cutting the window film laminate 30 after the latter has been placed on the mounting tool apparatus 20, thereby matching the window film laminate 30 on the to the size and shape of the working tool apparatus 20. A card squeegee 78 or the like may be used for drawing fluid from between the window film laminate 30 and the window 40 after the latter has been mounted and before the latter has been cured. A web roil 84 of double-sided tape is also included. Appropriate instructions may be included as well which define an installation process according to this invention.

It is believed that the process of the present invention is readily understood from the foregoing. However, a brief description is set forth below. The methodology of installing a laminate on a substrate includes sizing and shaping a foldable blank sheet to the size and shape of a substrate, generating a film mounting tool by cutting the blank sheet to the size and shape of the substrate, providing a thin laminate, joining mutually opposing major surfaces of the laminate to the film mounting tool in a close juxtaposed and generally coextensive relation for allowing reliable sizing and shaping of the laminate to the film mounting fool, delaminating a release sheet from the laminate while joined thereto so as to expose an adhesive layer of the laminate, and directly pressing the pressure-sensitive layer to the window by the film mounting tool.

The above embodiments have been described as being accomplished in a particular sequence, it will be appreciated, that such sequences of the operations may change and still remain within the scope of the invention. Also, other procedures may be added.

This invention may take oil various modifications and alterations without departing from the spirit and scope. Accordingly, this invention is not limited to the above-described embodiments, but is to be controlled by limitations set forth in the following claims and any equivalents thereof.

This invention also may be suitably practiced in the absence of any element not specifically disclosed herein. All patents and publications noted above, including any in the Background section are incorporated by reference into this document in total.

What is claimed is:

1. A method of installing a laminate on a substrate, the method comprising: generating a film mounting tool by cutting a blank sheet to generally match the size and shape of the substrate; providing a laminate; joining mutually opposing major surfaces the laminate to the film mounting tool so that both are in a generally juxtaposed and coextensive relationship with each other whereby the mounting tool supports the laminate; cutting the laminate so that its shape and size generally conforms to that of the film mounting tool; and applying the laminate by using the film mounting tool to press the laminate against the substrate.

2. The method of claim 1, wherein the film mounting tool includes one or more adhesive surfaces that is releasably attachable to the substrate.

3. The method of claim 2, wherein the film mounting tool is joined to the laminate by the one or more adhesive surfaces that are releasably attached to the laminate so that when joined the film mounting tool can carry and support the laminate.

4. The method of claim 1, wherein the laminate is joined to the film mounting tool in a manner to facilitate delaminating a release sheet from a laminate for exposing an adhesive layer of the laminate without damaging the laminate.

5. The method of claim 1, wherein the blank sheet is made of a foldable and pliable material that will not break in response to being folded or creased.

6. The method of claim 4, wherein the film mounting tool is relatively stiffer than the laminate that is to be carried in close juxtaposition therewith, whereby the film mounting tool is generally coextensive with the laminate to thereby reduce the likelihood of the laminate folding on itself while being carried along with the film mounting tool during installation as well as to facilitate pressing of the laminate on the substrate.

7. The method of claim 6, wherein the film mounting tool provided has a thickness in a range of about 5 mil to about 10 mil.

8. The method of claim 6, wherein the blank sheet provided is made of material from a group consisting of: paper, non-woven materials, and sheet polymers.

9. The method of claim 1, wherein generating the film mounting tool includes creasing the blank sheet against edges defining the boundary of the substrate.

10. The method of claim 1, wherein the laminate provided includes an adhesive on one surface thereof for facilitating laminating it to the substrate.

11. The method of claim 1, further including aligning the laminate on the substrate after applying a fluid to at least the substrate prior to applying the laminate thereto, whereby the laminate is easily movable to a preselected location relative to the substrate.

12. The method of claim 11, wherein mounting the laminate includes using the film mounting tool for aligning the laminate on the substrate until the laminate is in a preselected location.

13. The method of claim 11, further including delaminating the film mounting tool from the laminate following the laminate being installed on the substrate.

14. The method of claim 1, wherein the laminate provided is a substantially transparent sheet that is adapted to be placed on the substrate.

15. The method of claim 1, wherein the laminate provided is a window film that is from a group consisting of: solar window film, graphic design window film, privacy window film, security window film, frosted window film and any combination thereof.

16. The method of claim 15, wherein the window film laminate provided has a thickness dimension in a range of about 1 mil to about 6 mils.

17. The method of claim 16, wherein the window film has ultraviolet reflecting properties in the range of about 90% to about 100%.

18. The method of claim 17, wherein the window film has infrared reflecting properties in the range of about 0% to about 99%.

19. The method of claim 18, wherein the window film provides for transparency of visible light in the range of up to about 100%.

20. The method of claim 9, wherein the edges defining the boundary are formed by an intersection of the substrate and at least a portion of a window assembly framing the substrate.

21. The method of claim 1, wherein the laminate is placed on and releasably attached to the film mounting tool so as to facilitate the laminate being sized and shaped to the film mounting tool.

22. The method of claim 1, wherein the laminate is placed on and releasably attached to the film mounting tool so as to facilitate delaminating a release sheet from a laminate for exposing an adhesive layer of the laminate without damaging the laminate.

23. The method of claim 11, further including drawing a tool across a surface of the applied laminate to draw fluid from between the laminate and the substrate.

24. A method of forming an apparatus adapted for sizing, shaping, and supporting a laminate on a substrate, the method comprising: providing a foldable blank sheet; forming one or more folds in the blank sheet for generally matching a size and shape of a boundary of the substrate; and generating the apparatus by cutting the blank sheet adjacent the one or more folds so that its size and shape generally conform to the boundary of the substrate.

25. The method of claim 24, wherein the blank sheet provided includes one or more adhesive surfaces thereon that is adapted to be releasably attached to the substrate to facilitate cutting of the blank sheet to the size and shape of the substrate.

26. The method of claim 25, wherein the one or more adhesive surfaces is releasably attachable to the laminate whereby the latter may be carried and supported by the apparatus.

27. The method of claim 28, wherein the blank sheet provided is made of a material that will not break in response to being creased or folded.

28. The method of claim 25, wherein the apparatus supports and carries the laminate in close juxtaposed and generally coextensive relationship thereto.

29. The method of claim 28, wherein the blank sheet provided is relatively stiffer than the laminate to be laminated thereby reducing the likelihood of the laminate folding upon itself while being installed.

30. The method of claim 29, wherein the blank sheet provided has a thickness in a range of about 5 mil to about 10 mil.

31. The method of claim 30, wherein the blank sheet provided is made of materials of a group consisting of: paper, non-woven materials, and polymer materials.

32. The method of claim 30, wherein the one or more adhesive surfaces is a pressure-sensitive adhesive.

33. The method of claim 30, wherein the one or more adhesive surfaces includes a pressure-sensitive adhesive.

34. A film mounting tool apparatus adapted for sizing, shaping, and supporting a laminate to be applied on a substrate, the apparatus comprising: a blank sheet, that is made of a material that is foldable and able to be cut to conform it to the size and shape of a boundary of the substrate; the blank sheet includes one or more adhesive surfaces that are releasably attachable to the substrate to facilitate folding and cutting the blank sheet into the tool apparatus so that the tool apparatus matches generally to the boundary of the substrate; the one or more adhesive surfaces facilitate joining the tool apparatus to the laminate whereby the latter can be more precisely cut to match the size and shape of the tool apparatus, and the blank sheet material supports and controls movement of the cut laminate while the latter is applied to the substrate.

35. The film mounting tool apparatus of claim 34, wherein the blank sheet material that will not break in response to being folded.

36. The film mounting tool apparatus of claim 36, wherein the blank sheet is relatively stiffer than the laminate and is generally coextensive with the laminate to thereby reduce the likelihood of the laminate folding in on itself while being installed.

37. The film mounting tool apparatus of claim 37, wherein the blank sheet has a thickness in a range of about 5 mil to about 10 mil.

38. The film mounting tool apparatus of claim 37, wherein the blank sheet is made of at least a material from a group consisting of: paper, non-woven materials, and sheet polymers.

39. The film mounting tool apparatus of claim 36, wherein the one or more adhesive surfaces is made of at least a pressure-sensitive adhesive.

40. The film mounting tool apparatus of claim 36, wherein the one or more adhesive surfaces is such as to mount the laminate thereon in a manner whereby the laminate may have a release sheet thereof delaminated for exposing an adhesive layer without damaging the laminate.

41. A kit comprising:
a blank sheet that is made of a material that is foldable and able to be cut to conform it to the size and shape of a boundary of the substrate; the blank sheet includes one or more adhesive surfaces that are releasably attachable to the substrate to facilitate folding and cutting the blank sheet into a film mounting tool apparatus that matches generally the boundary of the substrate; the one or more adhesive surfaces facilitate joining the tool apparatus to the laminate whereby the latter can be more precisely cut to match the size and shape of the tool apparatus, and the blank sheet material supports and controls movement of the cut laminate while the latter is applied to the substrate; and
a thin laminate to be mounted on the substrate and joinable thereto so as to be sized and shaped to match the size and shape of the tool apparatus.

42. The kit of claim 42, further comprising: a tool for cutting the blank sheet and the laminate.

43. The kit of claim 42, further comprising: applying a fluid between the laminate and the substrate.

44. The kit of claim 42, further comprising: a tool for drawing a fluid from between the laminate and the substrate.

45. The kit of claim 42, further comprising: a spacer tool to facilitate cutting the blank sheet.

46. The kit of claim 42, wherein the blank sheet is made of a material that will not break in response to being folded.

47. The kit of claim 46, wherein the blank sheet is relatively stiffer than the laminate, and the blank sheet is generally coextensive to the laminate to thereby reduce the likelihood of the laminate folding on itself while being installed.

48. The kit of claim 47, wherein the blank sheet has a thickness in a range of about 5 mil to about 10 mil.

49. The kit of claim 46, wherein the blank sheet is made of a material from a group consisting of paper, non-woven materials, and sheet polymers.

50. The kit of claim 42, wherein the at least one adhesive article is made of at least a pressure-sensitive adhesive tape.

51. The kit of claim 42, wherein the laminate provided is a window film that is from a group consisting of: solar window film, graphic design window film, privacy window film, security window film, frosted window film and any combination thereof.

52. The kit of claim 51, wherein the window film laminate provided has a thickness dimension in a range of about 1 mil to about 6 mils.

53. The kit of claim 52, wherein the window film has ultraviolet reflecting properties in the range of about 90% to about 100%.

54. The kit of claim 53, wherein the window film has infrared reflecting properties in the range of about 0% to about 99%.

55. A method of installing a laminate, the method comprising: sizing and shaping a foldable blank sheet to the size and shape of a substrate; generating a film mounting tool by cutting the blank sheet to the size and shape of the substrate; providing a thin laminate:
joining mutually opposing major surfaces of the laminate to the film mounting tool in a close juxtaposed and generally coextensive relation for allowing sizing and shaping of the laminate to the film mounting tool; delaminating a release sheet from the laminate while joined so as to expose an adhesive layer of the laminate; and directly pressing the pressure-sensitive layer to the window by the film mounting tool.
